(19) United States
(12) Patent Application Publication
(10) Pub. No.: US 2015/0075756 A1
(43) Pub. Date: Mar. 19, 2015

(54) SURFACE TREATMENT FOR CORROSION RESISTANCE OF ALUMINUM

(71) Applicant: Carrier Corporation, Farmington, CT (US)

(72) Inventor: Thomas J. Garosshen, Glastonbury, CT (US)

(21) Appl. No.: 14/388,604

(22) PCT Filed: Mar. 28, 2013
(86) PCT No.: PCT/US2013/034246

§ 371 Date: Sep. 26, 2014

Related U.S. Application Data
(60) Provisional application No. 61/616,542, filed on Mar. 28, 2012.

(51) Int. Cl. F28F 1/12; C25F 3/04; B23P 15/26; C25F 1/00

(52) U.S. Cl. CPC F28F 1/12; C25F 1/00; C25F 3/04; B23P 15/26
USPC 165/133; 205/661; 29/890.045

(57) ABSTRACT

A heat exchanger having enhanced corrosion resistance is provided including at least one metal tube. The surface of the tube has a modified microstructure. At least one inhomogeneity has been removed or refined from the surface of the tube.

### CROSS REFERENCE TO RELATED APPLICATIONS

This application claims the benefit of U.S. Provisional Patent Application Ser. No. 61/616,542 filed Mar. 28, 2012, the contents of which are incorporated herein by reference thereto.

### BACKGROUND OF THE INVENTION

The invention relates generally to aluminum alloys and, more particularly, to corrosion resistance of aluminum alloys.

Due to its wide availability and excellent thermal conductivity properties, many heat exchangers are made from aluminum. Extruded aluminum headers and or tubes are used because of their low cost and ease of fabrication. Heat exchangers can be manufactured from several grades of aluminum, and extrudable and rolled aluminum products are most common. Aluminum alloy material typically used in constructing extruded tubes for use in heat exchangers is known as low alloy aluminum base (such as 3000 series aluminum). The aluminum materials typically contain tramp elements such as iron, silicon, magnesium, and the like as impurities introduced in the smelting process, especially when scrap material is used. These minor elements usually form intermetallic particles within the aluminum matrix that have unique electrochemical and chemical properties. These intermetallic particles may act as local anodes and cathodes that initiate the corrosion process and thereby impair the corrosion resistance of the base material.

Specifically, when exposed to a corrosive, aqueous environment, the aluminum is susceptible to localized corrosion modes such as pitting, intergranular, stress cracking (SCC) and general corrosion. Due to the presence of surface particles, or other abnormal surface features like pits, accelerated oxidation or corrosion is initiated in these areas and eventually degrades the entire surface. Pitting corrosion is known to significantly reduce fatigue strength and life. Typically, fatigue endurance limits are reduced by pitting to nominally half or less than the limit of uncorroded alloys. Many methods exist for increasing the corrosion resistance of aluminum alloys such as painting, electroplating, anodizing and chromating the surfaces of the metal. Many of these processes are expensive, many are environmentally unfriendly, and none offer long term low maintenance protection. For example, anodizing involves a complex and expensive multi-step procedure. Chromate passivation is less complex, but does not provide sufficient pitting corrosion protection to allow aluminum based materials to be used in a tropical environment for a long design life.

An all-aluminum heat exchanger, particularly one intended for use as a condenser or evaporator is continually exposed to a moisture containing environment and can be highly susceptible to corrosion. Localized corrosion, the usual process for aluminum alloys, results in pitting of the tube surface. Eventually as corrosion continues to eat away at the tubes, holes will form allowing one of the heat exchanger fluids to leak. Pitting corrosion rates are often fast enough to cause perforation of the tubing holding the refrigerant within a few years of service if the material is not properly prepared. Gradual loss of refrigerant results in lower efficiency operation of a cooling system, along with eventual system shut down. The release of refrigerants may also have adverse environmental impact.

### BRIEF DESCRIPTION OF THE INVENTION

According to one embodiment of the invention, a heat exchanger is provided including at least one metal tube. The surface of the tube has a modified microstructure. At least one inhomogeneity has been removed or refined from the surface of the tube.

According to another embodiment of the invention, a method of manufacturing a metal tube having enhanced corrosion resistance, for use in a heat exchanger, is provided including extruding a metal into a tube. The microstructure of the surface of the tube is modified by removing or refining inhomogeneities as the tube is extruded or immediately afterwards.

According to yet another embodiment of the invention, a method for manufacturing a metal tube having an enhanced corrosion resistance, for use in a heat exchanged, is provided including forming a sheet of metal into a tube having a desired shape. The edges of the metal are bonded together to form a seal of the tube. The microstructure of the surface of the tube is modified by removing or refining inhomogeneities of the metal before or after the tube is formed.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic drawing of an exemplary air conditioning system;

FIG. 2 is a cross-sectional view of a sample of aluminum alloy;

FIG. 3 is a cross-sectional view of the sample of aluminum alloy illustrated in FIG. 2 after being placed in a moist environment for a period of time;

FIG. 4 is a cross-section view of a second sample of aluminum alloy in accordance with an embodiment of the invention; and

FIG. 5 is diagram of a method of manufacturing an aluminum alloy tube in accordance with an embodiment of the invention; and

FIG. 6 is diagram of a method of manufacturing an aluminum alloy tube in accordance with an embodiment of the invention.

### DETAILED DESCRIPTION OF THE INVENTION

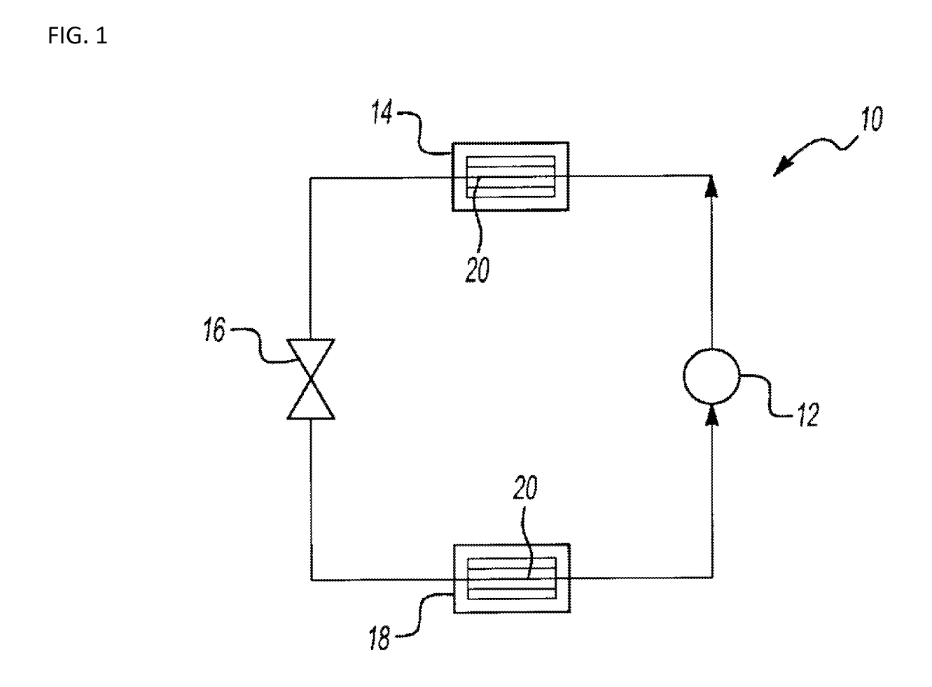

Referring now to FIG. 1, an air conditioning system 10 is illustrated. The system 10 includes a compressor 12, a heat rejecting heat exchanger also known as a condenser 14, an expansion device 16, and a heat accepting heat exchanger also known as an evaporator 18. A fluid, such as a refrigerant for example, circulates through the closed circuit system 10. After the refrigerant exits the compressor 12 at a high pressure and enthalpy, the refrigerant flows through the condenser 14 and loses heat, exiting the condenser 12 at low enthalpy and high pressure. As the refrigerant passes through the expansion device 16, the pressure drops. After expansion, the refrigerant flows through the evaporator 18 and exits at a high enthalpy and low pressure. The refrigerant re-enters and passes through the compressor 12, completely flowing through the system 10. Both the evaporator 18 and the condenser 14 include a plurality of tubes 20, which form a plurality of flow passages through which the refrigerant flows. In one embodiment, a plurality of fins (not shown) may extend from the heat exchanger tubes 20 to improve the heat transfer between two fluids. As known, the refrigerant accepts heat from a fluid that flows around the plurality of tubes 20 in the evaporator 18. Each tube 20 has a metal body and inner surface. In one embodiment, exemplary tubes 20 may be made of aluminum, such as an aluminum alloy from the 3000, 4000, 5000, 6000, or 8000 series for example. In another embodiment, tubes 20 may be made from an alternate metal material.

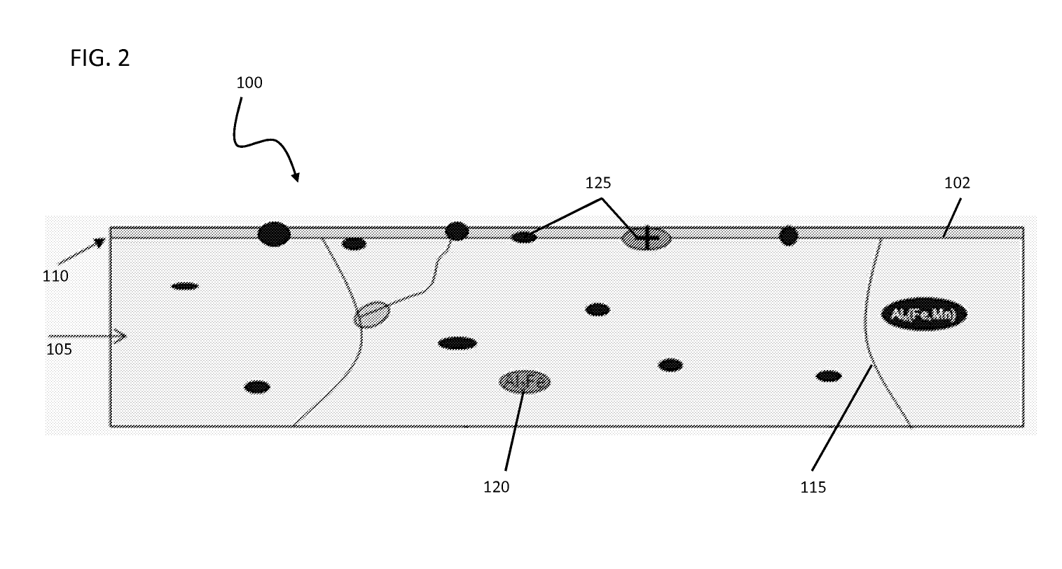

FIG. 2 illustrates an exemplary cross-section of first sample of aluminum alloy 100. Although an exemplary aluminum alloy is shown in the FIGS., additional metals and metal alloys that may be used to manufacture parts of a heat exchanger, such as a tube or fin for example, are within the scope of this invention. The aluminum alloy 100 includes an aluminum matrix 105 having a passive layer 110, such as a protective metal oxide for example, on a first surface 102. Grain boundaries 115 represent the interface between adjacent grains within the aluminum matrix 105. The aluminum matrix 105 includes intermetallic particles or second phase particles 120. These second phase particles 120 are distributed throughout the aluminum matrix 105 to enhance the strength and hardness of the aluminum alloy 100. In some cases, the second phase particles 120 are simply a result of contaminants in the alloy that are tolerated due to the high cost to remove them. The second phase particles 120 are formed during the thermal-mechanical processing of the alloy and, as a result, can form particles, inclusions, or inhomogeneities, on the surface of the aluminum alloy 100. These second phase particles 120 not only reduce the stability of the protective passive layer 110 but also result in the formation of localized galvanic coupling with the aluminum matrix 105 due to the difference in potential of the matrix 105 and the particles 120. This creates severe and highly localized pits of corrosion. Second phase particle 125 exemplifies a site of initiation of local corrosion.

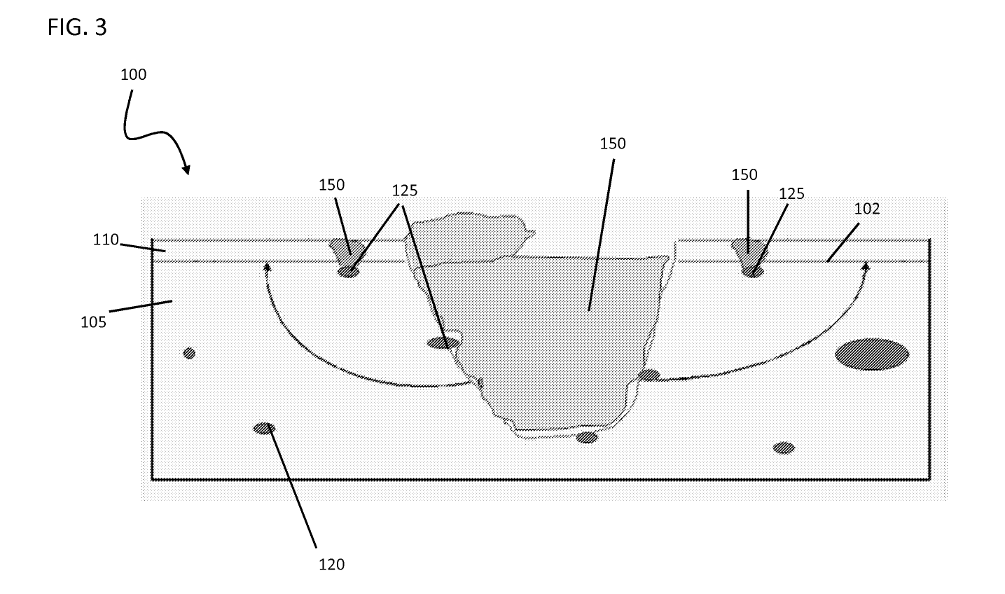

With reference now to FIG. 3, the exemplary cross-section of a sample of aluminum alloy 100 from FIG. 2 is illustrated after being placed in a moist environment for a period of time, allowing pitting corrosion to occur. When in a wet environment, second phase particles 120 initiate local galvanic coupling. In the illustrated example, second phase particles 125 located near the surface 102 act as local cathodes and the aluminum matrix 105 acts as an anode. This galvanic reaction creates corrosions pits 150 that grow exponentially in magnitude until the corrosion pit extends through the entire thickness of the aluminum matrix 105.

The corrosion resistance of an aluminum alloy, such as aluminum alloy 100 for example, may be improved by modifying the microstructure at the surface 102 of the aluminum alloy 100. Because the inhomogeneities at the surface 102 of the alloy 100 reduce the stability of the passive layer 110, removal or refinement of these inclusions will result in an alloy 100 having a greater corrosion resistance.

Various processes may be used to alter the surface composition of a component made from aluminum alloy 100. These processes may be applied to various parts of a heating ventilation and air conditioning system made of aluminum, such as a heat exchanger tube or a fin. In one embodiment, the inhomogeneities of the surface 102 may be refined or dissolved away by plastically deforming the surface 102 of the alloy. Methods for plastically deforming the surface 102 include shot peening, laser shock peening, ultrasonic peening, low plasticity burnishing, and other similar methods known to persons having ordinary skill in the art. Each of these methods creates a layer of compressive residual stress having a certain magnitude and depth. Such plastic deformation results in a generally homogeneous deformation of the surface 102 of the alloy 100. By creating a layer of compressive residual stress of a sufficient magnitude and depth, it may be possible to prevent or inhibit the growth of inclusions or pits that lead to pitting corrosion, and the growth of cracks such as those required for stress cracking corrosion.

In another embodiment, the inhomogeneities adjacent the passive layer 110 may be removed or refined by applying a heat source to the surface 102 of the alloy 100. Exemplary thermal processes include, but are not limited to, laser surface melting, laser surface alloying, laser cladding, thermal arc spray, plasma processes, and other similar processes known to persons having ordinary skill in the art. For those thermal processes using a laser, generally a high intensity laser is applied to the surface 102 of the alloy 100 for a relatively short duration as the tube is moved at a relatively high speed and collected on a spool. In a thermal process, the heat source causes the near surface region of the alloy to liquefy. The majority of the alloy 100 is unaffected by the heat, and therefore, acts as a heat sink to rapidly cool the melted surface, creating a new microstructure. These thermal processes produce enhanced corrosion resistance as a result of altering the surface composition and redistributing the impurities and second phase particles 120. The resultant aluminum alloy has a more uniform structure with superior homogeneity compared to conventional surfaces. For example, a laser surface melting process may completely melt or dissolve inclusions on the surface 102 of the alloy 100 or the surface alloy created using a laser surface alloying process will have compositional uniformity.

In another embodiment, the inhomogeneities of the passive layer 110 may be removed or refined by applying a chemical or electrochemical process to the alloy 100. For example, the aluminum alloy 100 may be placed in a chemical etching bath, which will attack the structural inhomogeneities by selectively leaching the second phase particles 120 from the surface 102 of the alloy 100 without damaging the alloy 100. The chemicals combined to form the bath will vary depending on the composition of the intermetallic particles being removed. Suitable bath solutions for selectively removing second phase particles from the surface of an aluminum alloy may include sodium hydroxide generally in the range of between 5 and 20 percent, hydrochloric nitric acid, hydrofluoric acid and combinations thereof. A chemically etched surface of an aluminum alloy may additionally be smoothed after being treated with a chemical solution to eliminate surface roughness and pits that may induce local corrosion. Exemplary processes for smoothing the surface of the alloy include, but are not limited to, rolling, burnishing, grinding, fine wire burnishing, and thermal processes.

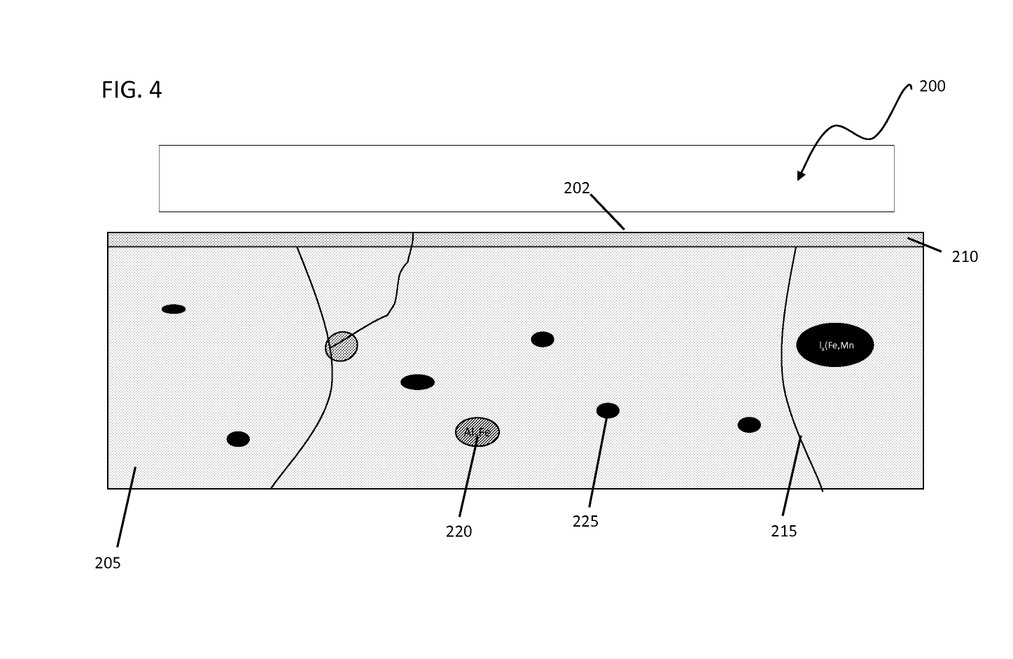

Referring now to FIG. 4, a cross-section of another sample of aluminum alloy 200 is illustrated. A process has been applied to the surface 202 of aluminum alloy 200 to improve its corrosion resistance. Similar to the sample shown in FIG. 2, the aluminum alloy 200 includes an aluminum matrix 205 and a passive layer 210 on the surface 202. Intermetallic or second phase particles 220 are still dispersed throughout the majority of the aluminum matrix 105. Unlike the aluminum alloy 100 illustrated in FIG. 2, the second phase particles 220 positioned near the surface 202 or the passive layer 210 were removed or refined by the process applied to the aluminum alloy 200 to improve its corrosive properties.

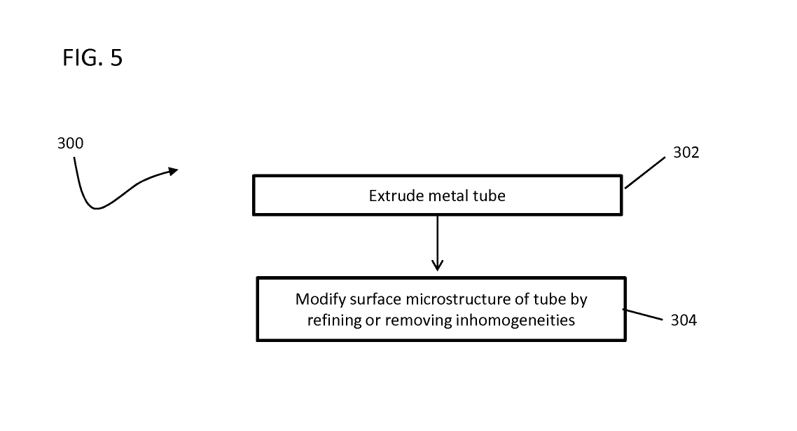

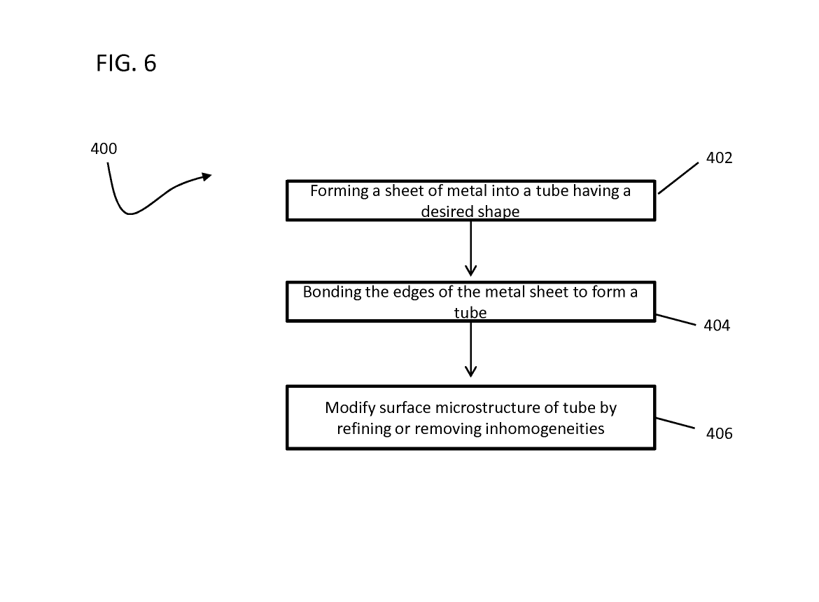

A method 300 of forming a tube, having an enhanced corrosion resistance, for use in a heat exchanger is illustrated in FIG. 5. As shown in block 302, a metal, such as aluminum alloy for example, is extruded into a desired shaped tube. In an exemplary embodiment, the metal may be extruded into a round, square, rectangular, or hexagonal tube. As the metal is extruded, shown in block 304, the microstructure of the surface of the tube is modified by removing or refining the inhomogeneities or inclusions created by second phase particles within the metal. Referring now to FIG. 6, another method 400 of forming a tube is illustrated. In block 402, a sheet of metal is formed, such as by rolling or bending for example, into a tube having a desired shape. An exemplary tube may be round, square, rectangular, or hexagonal in shape. The edges of the metal sheet are then bonded, such as by brazing or welding for example, to form a seam of the tube in block 404. In block 406, the microstructure of the surface of the metal tube is modified by removing or refining the inhomogeneities of inclusions created by the second phase particles within the alloy. The microstructure of the metal may be modified before or after being formed into a tube.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A heat exchanger having enhanced corrosion resistance comprising:
at least one metal tube including a surface having a modified microstructure, wherein at least one inhomogeneity has been removed or refined from the surface.

2. The heat exchanger having enhanced corrosion resistance according to claim 1, wherein the metal is an aluminum alloy selected from one of a 3000 series, a 4000 series, a 5000 series, a 6000 series and an 8000 series.

3. The heat exchanger having enhanced corrosion resistance according to claim 1, wherein a thermal process removed or refined the at least one inhomogeneity.

4. The heat exchanger having enhanced corrosion resistance according to claim 3, wherein a heat source melted the surface of the tube.

5. The heat exchanger having enhanced corrosion resistance according to claim 1, wherein a plastic deformation of the surface of the tube removed or refined the at least one inhomogeneity.

6. The heat exchanger having enhanced corrosion resistance according to claim 5, wherein the plastic deformation of the surface of the tube creates a compressive residual stress having a magnitude and depth.

7. The heat exchanger having enhanced corrosion resistance according to claim 1, wherein a chemical process or an electrochemical process removed or refined the at least one inhomogeneity.

8. The heat exchanger having enhanced corrosion resistance according to claim 7, wherein the chemical process dissolves at least one second phase particle forming the at least one inhomogeneity.

9. The heat exchanger having enhanced corrosion resistance according to claim 7, wherein the chemical or electrochemical process is followed by a smoothing process.

10. A method for manufacturing a tube for a heat exchanger having an improved corrosion resistance comprising:
extruding a metal into a tube; and
modifying a surface microstructure of the tube by removing or refining at least one inhomogeneity.

11. The method for manufacturing a tube for a heat exchanger having an improved corrosion resistance according to claim 10, wherein the metal is an aluminum alloy selected from one of a 3000 series, a 4000 series, a 5000 series, a 6000 series, and an 8000 series.

12. The method for manufacturing a tube for a heat exchanger having an improved corrosion resistance according to claim 10, wherein the surface of metal is modified by applying a thermal process.

13. The method for manufacturing a tube for a heat exchanger having an improved corrosion resistance, according to claim 10, wherein the surface of the metal is plastically deformed.

14. The method for manufacturing a tube for a heat exchanger having an improved corrosion resistance according to claim 10, wherein the surface of the metal is modified using a chemical or electrochemical process followed by a smoothing process.

15. A method for manufacturing a tube for a heat exchanger having an improved corrosion resistance comprising:
forming a sheet of metal into a tube of a desired shape;
bonding the edges of the metal together to seal the tube; and
modifying a surface microstructure of the tube by removing or refining at least one inhomogeneity.

16. The method for manufacturing a tube for a heat exchanger according to claim 15, wherein the metal is an aluminum alloy selected from one of a 3000 series, a 4000 series, a 5000 series, a 6000 series, and an 8000 series.

17. The method for manufacturing a tube for a heat exchanger according to claim 15, wherein the surface microstructure of the metal is modified or refined after being formed into a tube.

18. The method for manufacturing a tube for a heat exchanger according to claim 15, wherein the surface of the metal is modified by applying a thermal process.

19. The method for manufacturing a tube for a heat exchanger according to claim 15, wherein the surface of the metal is plastically deformed.

20. The method for manufacturing a tube for a heat exchanger according to claim 15, wherein the surface of the metal is modified using a chemical or electrochemical process followed by a smoothing process.
